(19) United States
(12) Patent Application Publication
(10) Pub. No.: US 2010/0146960 A1
(43) Pub. Date: Jun. 17, 2010

(54) EXTERNALLY MOUNTED VARIATOR FOR SPLIT TORQUE TRANSMISSION

(75) Inventors: Glen P. Calvert, Washington, IL (US); Darren J. Hopf, Peoria, IL (US); Tony L. Marcott, Edwards, IL (US); Anandkumar Dhanaraj, Coimbatore (IN)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 12/620,096

(22) Filed: Nov. 17, 2009

Related U.S. Application Data
(60) Provisional application No. 61/138,401, filed on Dec. 17, 2008.

(51) Int. Cl. F16H 61/40

(52) U.S. Cl. 60/487

(57) ABSTRACT

A split torque transmission for a work machine is provided. The split torque transmission includes a transmission housing. A variator pump is mounted to an exterior surface of the transmission housing. A variator motor is operably coupled to the variator pump and mounted to the exterior surface of the transmission housing.

### RELATED APPLICATIONS

This application is based upon and claims the benefit of priority from U.S. Provisional Application No. 61/138,401 by Glen P. Calvert et al., filed Dec. 17, 2008, the contents of which are expressly incorporated herein by reference

### TECHNICAL FIELD

This patent disclosure relates generally to split torque transmissions and, more particularly to a split torque transmission having an externally mounted variator.

### BACKGROUND

Work machines, such as wheel loaders, track loaders, bulldozers and backhoes typically use a transmission to translate the rotational speed of an engine to a drive speed. These transmissions are generally operable to provide a series of gear ratios that translate the speed of the engine into different drive speeds. Some work machines are designed to work in low speed ranges and require precise speed control through these low speed ranges. To achieve this speed control, a split torque transmission may be used. A split torque transmission combines the outputs of a hydrostatic transmission and a mechanical transmission to rotate a drive shaft and move the machine.

Providing both a hydrostatic transmission and a mechanical transmission can raise issues with respect to the serviceability of the transmission. In particular, packaging the elements needed for both a hydrostatic transmission and a mechanical transmission in a single transmission unit may make it difficult to access some of the transmission components to perform service. This could lead to more time-consuming and costly service operations. Additionally, packaging the hydrostatic transmission and mechanical transmission in a single transmission unit may create issues with respect to the size and configuration of the transmission that make it more difficult to efficiently fit the transmission into the machine.

### SUMMARY

The disclosure describes, in one aspect a split torque transmission for a work machine. The split torque transmission includes a transmission housing and a variator pump mounted to an exterior surface of the transmission housing. A variator motor is operably coupled to the variator pump and mounted to the exterior surface of the transmission housing.

In another aspect, the disclosure describes a machine including an engine and a mechanical transmission operably coupled to the engine and housed in a transmission housing. The machine further includes a hydrostatic transmission including a variator pump and a variator motor. The variator pump is operably coupled to the engine and mounted to an exterior surface of the transmission housing and the variator motor is operably coupled to the variator pump and mounted to the exterior surface of the transmission housing.

According to another aspect, the disclosure describes a transmission including a mechanical transmission housed in a transmission housing and having an output and a hydrostatic transmission including a variator pump and a variator motor. The variator pump is mounted on an exterior surface of the transmission housing and the variator motor is operably coupled to the variator pump and is mounted on the exterior surface of the transmission housing. The variator motor is operable to transmit torque to the output of the mechanical transmission.

### BRIEF DESCRIPTION OF THE DRAWINGS

FIG. 1 is a schematic block diagram of a machine with a split torque transmission according to the disclosure.

FIG. 2 is a perspective view of a split torque transmission according to the disclosure.

FIG. 3 is another perspective view of a split torque transmission according to the disclosure.

### DETAILED DESCRIPTION

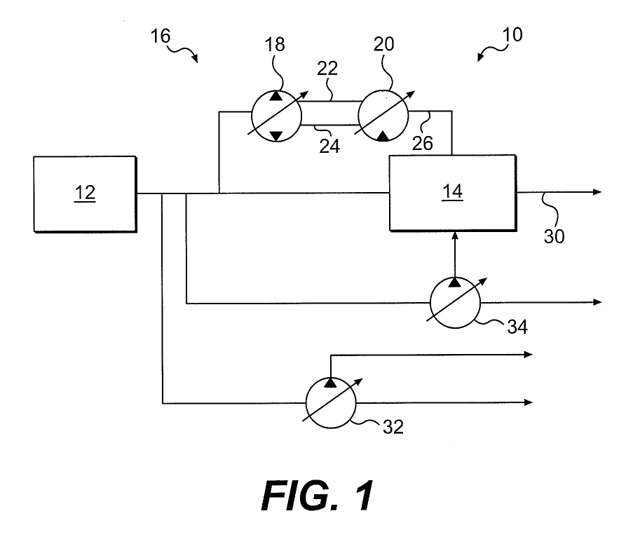

This disclosure relates to a split torque transmission. Referring to FIG. 1 of the drawings, a machine is schematically shown that includes a split torque transmission 10 that is operably coupled to an engine 12. The engine 12 can be, for example, a diesel engine, a gasoline engine, a natural gas engine, a gas-turbine engine, or any other engine known in the art. The split torque transmission 10 includes a mechanical transmission 14 and a hydrostatic transmission 16 and can be configured to convert the rotational speed of the engine 12 into, for example, a drive speed for the machine. The machine can be any type of machine that may utilize a split torque transmission, including particularly machines that operate at low speeds and where precise speed control is desired through the low speed ranges. Some examples of such machines include wheel loaders, track loaders, backhoes and tractors. The machines of FIG. 1 may be equipped with one or more work elements such as loader buckets, backhoe buckets, forks and/or blades.

In the illustrated embodiment, the hydrostatic transmission 16 includes a variator pump 18, which may comprise a variable displacement pump, drivingly connected to the engine 12 through a suitable input gear or gear arrangement. The illustrated hydrostatic transmission 16 further includes a variator motor 20, which may comprise a fixed or a variable displacement motor. The variator motor 20 may be fluidly connected to the variator pump 18 through appropriate fluid conduits 22, 24. An output shaft 26 extends from the variator motor 20. The variator motor 20 is operable to rotate the output shaft 26 in response to a pressurized fluid flow directed through the variator motor 20 by the variator pump 18. In a known manner, the speed and torque of the output shaft 26 can be varied by varying the volumetric displacements of the variator motor 20 and the variator pump 18.

The mechanical transmission 14 is also drivingly connected to the engine 12 and is operable to adjust the speed and torque provided by the engine. In a known manner, the mechanical transmission 14 may include one or more gear assemblies and clutch assemblies. In this case, the mechanical transmission 14, and the split torque transmission 10 as a whole, connects to the engine 12 via an input shaft 28 and is operable to rotate an output shaft 30, which may be drivingly connected to the drivetrain of the machine. The output of the hydrostatic transmission 16 may be selectively combined with the output of the mechanical transmission 14 by connecting their respective output shafts 26, 30 via a suitable gear arrangement.

To the extent the machine is provided with a work implement, an implement pump 32 may be provided with the split torque transmission 10. As shown in FIG. 1, the implement pump 32 may be drivingly connected to the engine 12 and adapted to provide pressurized hydraulic fluid for moving and/or operating a work implement of the machine. Additionally, the implement pump 32 may have an associated charge pump 34 that also could be drivingly connected to the engine 12 and operable to pre-pressurize the hydraulic fluid before it is supplied to the implement pump 32 in order to reduce the work and/or energy that the implement pump must provide. The implement and charge pumps 32, 34 may be fixed or variable displacement pumps as shown in FIG. 1.

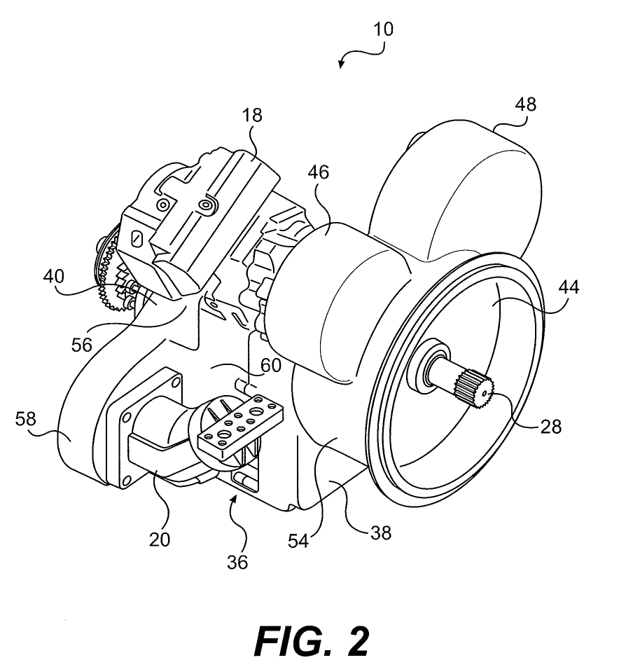

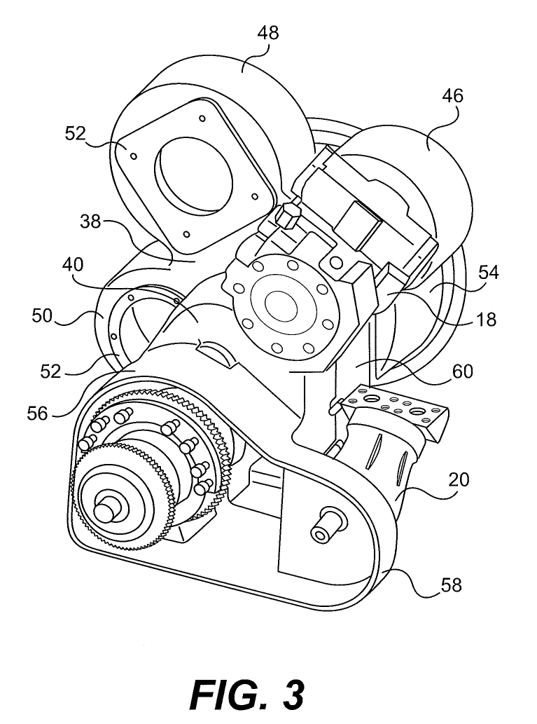

The split torque transmission 10 can further include a transmission housing 36 within which at least a portion of the mechanical transmission 14 may be housed. In the illustrated embodiment, as shown in FIGS. 2 and 3, the transmission housing 36 includes first and second housing parts 38, 40 that are connected together via bolts. The illustrated first housing part 38 is arranged closest the engine and the end that faces the engine, in this case, includes an outward facing cup-shaped recess 44 with a central opening out which the input shaft 28 for the transmission extends. This cup shaped recess 44 may be connectable with a corresponding structure on an engine block associated with the engine or some other machine structure.

In order to allow for easier access to the variator pump 18 for service operations or the like, the variator pump 18 can be mounted on an exterior surface of the transmission housing 36. In this way, the variator pump 18 could be serviced without having to open the transmission housing 36. To this end, for receiving the variator pump 18, the illustrated first housing part 38 includes at least one outwardly extending pump mounting portion 46 that has an exterior surface on which the variator pump 18 can be mounted. In this case, the first housing part 38 includes three outwardly extending pump mounting portions: a mounting portion 46 for the variator pump 18, a mounting portion 48 on which the implement pump 32 can be mounted and a mounting portion 50 on which the charge pump 34 can be mounted. For receiving the respective pumps, the exterior surface of each of the pump mounting portions 46, 48, 50 can include a respective mounting pad 52. In this case, the mounting pads 52, and, as shown in FIG. 2, the variator pump 18, are provided on the side of the pump mounting portions 46, 48, 50 facing away from the engine (i.e., the input end of the transmission housing 36).

Each of the pump mounting portions 46, 48, 50 has a generally cylindrical configuration and extends outward from a forward (relative to the location of the engine) generally cylindrical section 54 of the first housing part 38. One or more gear assemblies that drivingly connect the variator, implement and charge pumps 18, 32, 34 to the engine 12 via the transmission input shaft 28 can be contained in the respective pump mounting portions 46, 48, 50 and the cylindrical section 54 of the first housing part 38.

The second housing part 40 of the illustrated transmission housing 36 is arranged further from the engine and includes a main portion 56 that mates with the first housing part 38. The second housing part 40 also includes an outwardly extending motor mounting portion 58 at its end furthest from the engine. Again, to allow for easier access to the variator motor 20 for service or the like, the variator motor 20 can be mounted on an exterior surface of the transmission housing 36 and in particular in the illustrated arrangement on the motor mounting portion 58. In this case, the variator motor 20 is mounted on the side of the motor mounting portion 58 facing towards the engine such that the variator motor 20 and variator pump 18 face each other. This arrangement makes it easier to provide the fluid conduit connections between the variator motor 20 and the variator pump 18.

In the illustrated embodiment, the variator motor 20 is mounted on the exterior surface of the motor mounting portion 58 such that the output shaft 26 of the variator motor 20 extends into the interior of the motor mounting portion 58 of the transmission housing 36. The gear arrangement that connects the output shaft 26 of the variator motor 20 with the output shaft 30 of the mechanical transmission 14 can be contained within the second housing part 40 of the transmission housing 36 including in the interior of the motor mounting portion 58. Additionally when assembled, the first and second housing parts 38, 40 define a central generally box-shaped enclosure 60 that extends between the motor mounting portion 58 and the pump mounting portions 46, 48, 50 and in which portions of the gear and clutch assemblies associated with the mechanical transmission 14 can be contained.

### INDUSTRIAL APPLICABILITY

The present disclosure is applicable to any machine that utilizes a split torque transmission such as wheel loaders, track loaders, backhoes and tractors. With such machines, mounting the variator pump and variator motor of the split torque transmission on the external surface of the transmission housing improves serviceability of the transmission because the variator pump and motor can be accessed without opening the transmission housing.

Additionally, because spilt torque transmissions require both a hydrostatic component and a mechanical component, issues can arise with respect to the overall size and configuration of the transmission that can make it more difficult to package the transmission into a machine. Arranging the variator motor and the variator pump on an external surface of the transmission housing can provide additional flexibility with regard to the overall packaging of a split torque transmission that can facilitate optimization of the arrangement and fit of the transmission in the machine.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A split torque transmission for a work machine comprising:
a transmission housing;
a variator pump mounted to an exterior surface of the transmission housing; and
a variator motor operably coupled to the variator pump and mounted to the exterior surface of the transmission housing.

2. The split torque transmission of claim 1 further including a mechanical transmission at least a portion of which is arranged in the transmission housing.

3. The split torque transmission of claim 1 wherein the transmission housing includes a first housing part and a second housing part.

4. The split torque transmission of claim 3 wherein the variator pump is mounted to the exterior surface of the first housing part and the variator motor is mounted to the exterior surface of the second housing part.

5. The split torque transmission of claim 1 wherein the transmission housing includes a mounting portion configured for mounting of an implement pump on an exterior surface thereof.

6. The split torque transmission of claim 1 wherein the transmission housing includes a mounting portion configured for mounting of a charge pump on an exterior surface thereof.

7. The split torque transmission of claim 2 wherein the variator motor is operable to transmit torque to an output side of the mechanical transmission.

8. The split torque transmission of claim 1 wherein the exterior surface of the transmission housing includes a pump mounting portion on which the variator pump is mounted.

9. The split torque transmission of claim 1 wherein the exterior surface of the transmission housing includes a motor mounting portion on which the variator motor is mounted.

10. A machine comprising:
an engine;
a mechanical transmission operably coupled to the engine at least a portion of which is housed in a transmission housing; and
a hydrostatic transmission including a variator pump and a variator motor, wherein the variator pump is operably coupled to the engine and mounted to an exterior surface of the transmission housing and the variator motor is operably coupled to the variator pump and mounted to the exterior surface of the transmission housing.

11. The machine of claim 10 wherein the transmission housing includes a first housing part and a second housing part.

12. The machine of claim 11 wherein the variator pump is mounted to the exterior surface of the first housing part and the variator motor is mounted to the exterior surface of the second housing part.

13. The machine of claim 10 wherein the transmission housing includes a mounting portion configured for mounting of an implement pump on an exterior surface thereof.

14. The machine of claim 10 wherein the transmission housing includes a mounting portion configured for mounting of a charge pump on an exterior surface thereof.

15. The machine of claim 10 wherein the variator motor is operable to transmit torque to an output side of the mechanical transmission.

16. The machine of claim 10 wherein the exterior surface of the transmission housing includes a pump mounting portion on which the variator pump is mounted.

17. The split torque transmission of claim 10 wherein the exterior surface of the transmission housing includes a motor mounting portion on which the variator motor is mounted.

18. A transmission:
a mechanical transmission at least a portion of which is housed in a transmission housing and having an output; and
a hydrostatic transmission including a variator pump and a variator motor, wherein the variator pump is mounted on an exterior surface of the transmission housing and the variator motor is operably coupled to the variator pump and is mounted on the exterior surface of the transmission housing, the variator motor being operable to transmit torque to the output of the mechanical transmission.

19. The transmission of claim 18 wherein the transmission housing includes a first housing part and a second housing part.

20. The transmission of claim 19 wherein the variator pump is mounted to the exterior surface of the first housing part and the variator motor is mounted to the exterior surface of the second housing part.
